(19) United States
(12) Patent Application Publication
(10) Pub. No.: US 2025/0038505 A1
(43) Pub. Date: Jan. 30, 2025

(54) DEVICE FOR ROUTING LINES, PIPES, AND/OR CABLES THROUGH A BUILDING COMPONENT

(71) Applicant: Hilti Aktiengesellschaft, Schaan (LI)

(72) Inventors: Brendan Voss, Muenchen (DE); Eric Gosling, Landsberg am Lech (DE); Chad Stroike, Roanoke, TX (US); Mario Paetow, Landsberg am Lech (DE); Günter Preschl, Ulm (DE); Daniel Markus, Augsburg (DE)

(73) Assignee: Hilti Aktiengesellschaft, Schaan (LI)

(21) Appl. No.: 18/715,152

(22) PCT Filed: Nov. 23, 2022
(86) PCT No.: PCT/EP2022/082989

§ 371 Date: May 31, 2024

(30) Foreign Application Priority Data
Dec. 3, 2021 (EP) 21212162.8

(51) Int. Cl. H02G 3/22; A62C 3/16

(52) U.S. Cl. CPC H02G 3/22; A62C 3/16

(57) ABSTRACT

A device for routing lines, pipes, and/or cables through a building part has a housing with a first and an opposite second wall, a curved first and a curved second seal in a housing interior, end regions whose first and second seals are connected to the first and second wall, respectively, and a central region whose first and second seals extend towards the second and first wall, respectively. The first and second seals have a common extension region longitudinal to the device. The first and second seals cooperate through the central regions. The third seal is assigned to the first seal, and the fourth seal is assigned to the second seal, in the common extension region. The third and fourth seals cooperate.

### TECHNICAL FIELD

The invention relates to devices for routing lines, pipes, and/or cables through building components, such as building walls and the like, and to measures for preventing the passage of fire gases and smoke through such a device.

### TECHNICAL BACKGROUND

Known devices for routing lines, pipes, and/or cables through building components usually have features to achieve a desired smoke impermeability, fire gas impermeability, and optical seal or opaqueness. For this purpose, it is known, for example, to use brush curtains or loop curtains.

Good gas tightness is important, in particular when using the device between rooms in healthcare facilities in order to prevent the propagation of pathogens in the air. Even when the device is used in data centers, the gas tightness is an important criterion, since temperature losses can be avoided due to the control of the air flow and a desired heat regulation can be achieved.

A line feedthrough for routing lines and the like through a building component is known from the document U.S. Pat. No. 20,182,64298 A1. The line feedthrough has a rectangular cross section with openings at the end regions. Crossed brushes are arranged in each case in the region of the openings of the line feedthrough. Curved foam elements having intumescent material are in each case arranged within the crossed brushes in the longitudinal direction, end regions of the foam elements being arranged on respective opposite walls of the line feedthrough. In order to close a passage in the longitudinal direction, the foam elements cooperate with one another by means of trapezoidal blocks, which are each arranged in a central region of the foam elements.

With the embodiment disclosed in U.S. Pat. No. 20,182,64298 A1, a desired gas tightness can potentially not be achieved, since in the case of loading the line feedthrough with lines or the like in the region of the trapezoidal blocks, inadequate sealing may be present, since only relatively little material is available for sealing with respect to the lines routed through the line feedthrough. In addition, the flexible foam material of the blocks, which is provided, in particular, in order to achieve a good sealing effect in the loaded state of the line feedthrough, potentially produces an inadequate sealing effect during cooperation of the foam blocks in the unloaded state of the line feedthrough. The gas tightness of the line feedthrough cannot be compensated to the desired extent by the crossed brushes either.

The object of the present invention is to provide a device for routing lines, pipes, and/or cables through a building part, in which device a gas tightness of the device is improved.

### DISCLOSURE OF THE INVENTION

This object is achieved by the device for routing lines, pipes, and/or cables according to claim 1.

Further embodiments are specified in the dependent claims.

According to one aspect of the invention, a device is provided for routing lines, pipes, and/or cables through a building part, having a housing with a housing wall, the housing having an axial passage channel which is delimited by the housing wall, extends in the longitudinal direction, and has an opening in each case at opposite ends, the housing having a first wall and a second wall opposite the first wall, a first sealing means having a curved shape being arranged in the housing interior, the end regions of which first sealing means in each case being operatively connected to the first wall and the central region of which first sealing means extending in the direction of the second wall, and a second sealing means having a curved shape being arranged in the housing interior, the end regions of which second sealing means being operatively connected to the second wall and the central region of which second sealing means extending in the direction of the first wall, and the first sealing means and the second sealing means having a common extension region in the longitudinal direction of the device.

According to the invention, the first sealing means and the second sealing means cooperate with one another by means of the central regions, a third sealing means being assigned to the first sealing means in the common extension region and a fourth sealing means being assigned to the second sealing means in the common extension region, and the third sealing means and the fourth sealing means cooperating with one another.

The present solution has the advantage that gas tightness, for example with respect to fire gases, smoke, but also with respect to air exchange, is improved compared to known embodiments. This is achieved, firstly, in that the curved, in particular planar first and second sealing means cooperate directly with one another and thus a large contact surface is made available between the first sealing means and the second sealing means.

Secondly, the third and fourth sealing means provided in the region of the common extension region improve gas tightness both in the unloaded state of the device or line feedthrough and in a loaded state, for example loaded with lines, pipes, cables, or the like.

In the device according to the invention, no manual opening or closing of the device for routing lines, pipes, and/or cables through the device is additionally required. Passage of gas through the device is greatly reduced, not only in the unloaded state but also in a partially loaded or fully loaded state of the device. This can be achieved, for example, by means of a resilient and flexible design for the first sealing means and second sealing means, which, however, are pressed against one another in both the unloaded state and in the loaded state and thus reduce or prevent passage of gas in this region.

The common extension region should be understood to mean a region that points in the longitudinal direction of the device and that results from an intersection of an extension region of the first sealing means extending in the longitudinal direction of the device and an extension region of the second sealing means extending in the longitudinal direction of the device. Preferably, the common extension region and the extension regions of the sealing means are substantially identical.

The fact that a third sealing means is assigned to the first sealing means in the common extension region and a fourth sealing means is assigned to the second sealing means in the common extension region should be understood to mean that the third sealing means and the fourth sealing means are arranged in the common extension region in the longitudinal direction of the device with a first end region facing the first sealing means and the second sealing means, respectively. A second end region of the third sealing means and of the fourth sealing means facing away from this first end region may be located outside the extension region in the longitudinal direction of the device. Preferably, the second end region of the third sealing means and of the fourth sealing means is also arranged within the common extension region in the longitudinal direction of the device.

The third sealing means and the fourth sealing means each form, in particular, a sealing plane or sealing surface, it being possible for the sealing plane of the third sealing means and the sealing plane of the fourth sealing means to be substantially congruent and also at an angle to one another, preferably in the longitudinal direction of the device. Preferably, together with the fourth sealing means, the third sealing means closes a cross section of the device virtually completely or preferably completely in the unloaded state of the device. The ends of the third sealing means and of the fourth sealing means or of sealing elements of said sealing means that face one another may cooperate so as to be flush with one another or, for example, engage in one another in a comb-like manner.

The housing of the device according to the invention preferably has a rectangular or square cross section. The device preferably comprises two housing parts which can be brought into operative connection with one another. Each housing part may have an, in particular, U-shaped cross section.

In an advantageous embodiment of the invention, the third sealing means and/or the fourth sealing means is connected to the first sealing means and/or to the second sealing means. respectively. As a result, complete sealing of the cross section of the device by means of the third sealing means and fourth sealing means is achieved in a structurally simple manner. In addition, assembly is simplified, since the third sealing means and/or the fourth sealing means can be connected to the relevant sealing means prior to installation of the first sealing means and second sealing means on the relevant housing part.

The third sealing means and/or the fourth sealing means is preferably connected to the first sealing means and/or to the second sealing means, respectively, by means of an adhesive connection or by means of a welded connection. As a result, a secure and reliable connection can be achieved.

The third sealing means and/or the fourth sealing means may be connected to the first wall and/or to the second wall, respectively, by a holding means. In this way, flexible positioning and alignment of the third sealing means and/or fourth sealing means can be achieved, the position and orientation of the third sealing means and/or fourth sealing means remaining unchanged at least in the region of arrangement on the relevant wall, both when the device is loaded and unloaded.

In an advantageous development of the invention, the holding means is designed to secure an end region of the first sealing means and second sealing means to the first wall and second wall, respectively. As a result, the holding means already provided for securing an end region of the first sealing means and of the second sealing means is also used for the arrangement of the third sealing means and fourth sealing means, respectively, and no separate component is required for this purpose. In addition, the third sealing means and the fourth sealing means can be secured to the wall of the device in one step with the securing of the end region of the first sealing means and of the second sealing means, respectively.

Particularly good sealing of the device is achieved when a fifth sealing means is assigned to the first sealing means in the common extension region and a sixth sealing means is assigned to the second sealing means in the common extension region, the fifth sealing means and the sixth sealing means cooperating with one another. The fifth and sixth sealing means are preferably arranged on a different side of the central regions of the first and second sealing means from the third and the fourth sealing means in the longitudinal direction.

In an advantageous embodiment of the invention, further sealing means may be provided in a manner comparable to the third to sixth sealing means, in particular so as to be offset with respect to the other sealing means in the longitudinal direction of the device in order to further improve sealing.

The third sealing means and/or the fourth sealing means and/or the fifth sealing means and/or the sixth sealing means may have at least two sealing elements in order, in particular, to further improve sealing. Sealing planes of the individual sealing elements may be arranged both parallel to one another and at an angle to one another. In addition, the sealing planes of the individual sealing elements may be arranged perpendicularly to the longitudinal direction of the device or be at an angle relative to the longitudinal direction.

In an embodiment of the invention that is advantageous for improving gas tightness, the third sealing means and/or the fourth sealing means and/or the fifth sealing means and/or the sixth sealing means each have inverted sealing elements in particular in the region of arrangement on the first sealing means or second sealing means, as applicable, the two end regions of the sealing elements being arranged so as to be flush with one another.

In order to improve sealing in a partially or completely occupied state of the device, the third sealing means and/or the fourth sealing means and/or the fifth sealing means and/or the sixth sealing means may each have inverted sealing elements in particular in the region of arrangement on the first sealing means or second sealing means, as applicable, the two end regions of the sealing elements being offset with respect to one another. Alternatively, two separate sealing elements may be provided which are offset with respect to one another by means of end regions facing away from a holder. In one embodiment of the sealing elements as brushes, if the device is loaded accordingly, this results, for example, in only brushes of the sealing element having a larger extension being deformed in a V-shaped manner through the line, pipe, or the like, and the other brush remaining unchanged with respect to the unloaded state with a significant sealing effect.

In an advantageous embodiment of the invention, the first sealing means and the second sealing means are designed as a foam element. Material properties of the foam can be selected such that particularly good sealing is achieved both in the unloaded and in the loaded state of the device. The foam may also have intumescent properties.

The third sealing means and/or the fourth sealing means and/or the fifth sealing means and/or the sixth sealing means or the respective sealing elements may be designed to have lamellae, brushes, bristles, strips, bands, or tube elements, these in particular each forming a sealing plane or sealing surface. The sealing elements are preferably flexible and/or resilient, a width of the sealing elements preferably being many times smaller than a length of the sealing elements in the extension direction of the sealing elements, and preferably also smaller than the lines, pipes, cables, or the like routed through the device.

The third sealing means and/or the fourth sealing means and/or the fifth sealing means and/or the sixth sealing means or the respective sealing elements may be designed to comprise plastics material, in particular polyamide, nylon or polyester, rubber, for example vulcanized rubber or EPDM, and/or biological material, in particular horse hair or hog bristles.

In order to further improve the gas tightness, a sealing arrangement may be provided in each case in the region of the openings of the device, which sealing arrangement may be designed in a manner comparable to the third to sixth sealing means and, in particular, in each case close a complete cross section of the device in the unloaded state of the device. The relevant sealing arrangement may, in particular, have multiple sealing elements which are arranged, in particular, parallel to one another and extend in a main direction. Furthermore, a further sealing arrangement may also be provided in the region of each opening, which further sealing arrangements are designed, in particular, having sealing elements which extend in a main direction, are at an angle relative to the sealing element of the sealing arrangement, and are preferably at an angle of approximately 90°.

At least one intumescent element may be provided in order to achieve secure closing of the device in the event of a fire and in order to prevent a transfer of flames between the openings for as long as possible. The intumescent element may be a separate element, for example connected to the housing. If separate intumescent elements are provided, the sealing means may advantageously be optimized with respect to the material selection in such a way that the best possible sealing against gases and the like is achieved. Alternatively or additionally, a sealing means may also have intumescent properties.

Further advantages can be found in the following description of the figures. Embodiments of the present invention are shown in the figures. The figures, the description, and the claims contain numerous features in combination. A person skilled in the art will expediently also consider the features individually and combine them to form further meaningful combinations.

### BRIEF DESCRIPTION OF THE DRAWINGS

Embodiments will be explained in more detail below with reference to the accompanying drawings. In the figures, identical and equivalent components are provided with the same reference signs.

In the figures:

FIG. 1 is a sectional view of an unloaded device for routing lines, pipes, and/or cables through a building part having a passage channel, the device being designed having two parts that can be brought into operative connection with one another, and the device having, in addition to two curved sealing means, multiple sealing means connected to these sealing means;

FIG. 2 is a sectional view of the device according to FIG. 1, the device being shown in a loaded state with a line routed through the device;

FIG. 3 is a sectional view of part of the device according to FIG. 1 and FIG. 2;

FIG. 4 is a sectional view of part of an alternatively designed device in which a sealing means is arranged on a housing wall via a holding means;

FIG. 5 is a sectional view of part of a further alternatively designed device in which the sealing means is designed having curved sealing elements;

FIG. 6 is a sectional view of part of a further alternatively designed device in which two sealing means at an angle to one another are arranged in the region of a holding means;

FIG. 7 is a simplified representation of a sealing means in isolation; and

FIG. 8 is a simplified representation of an alternatively designed sealing means in isolation.

### DESCRIPTION OF EMBODIMENTS

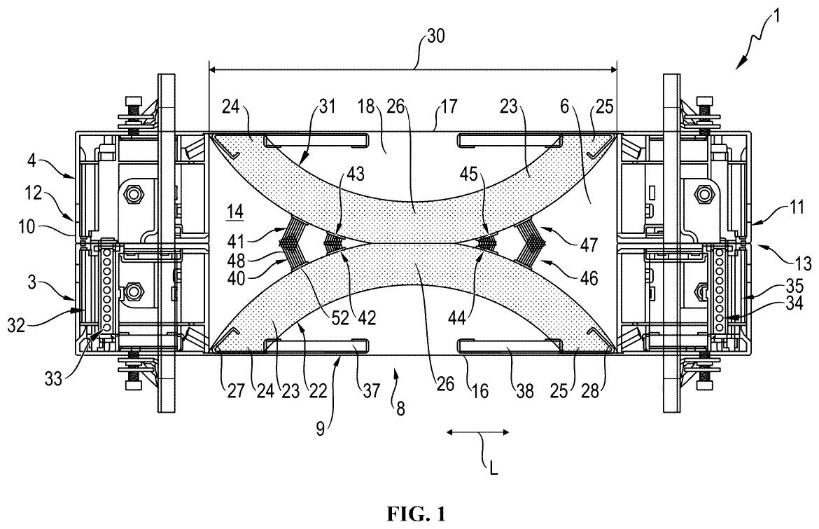

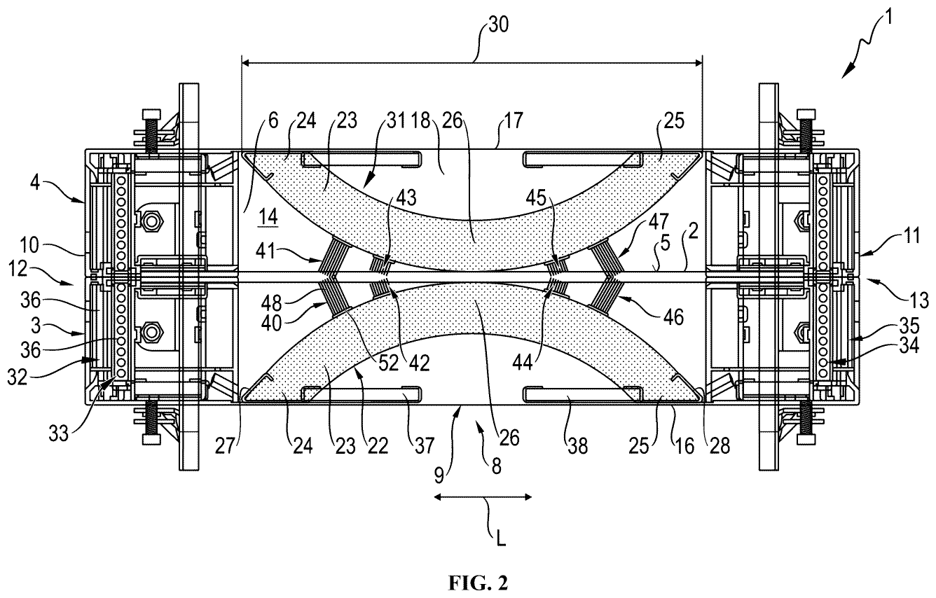

FIG. 1 to FIG. 3 show a device 1 for routing one or more lines, pipes, cables, or the like, such as power lines, water lines, gas lines, and the like, through a building part, such as a building wall, a ceiling, and a floor.

The device 1 does not require any manual opening or closing in order to route lines or the like through the device 1. Rather, these can be routed through the device 1 without further measures.

According to the invention, the device 1 is designed with two parts 3, 4, each having a substantially U-shaped cross section, which parts can be detachably arranged on one another according to FIG. 1. The first part 3 and the second part 4 are substantially identical to one another. In the interconnected state of the parts 3, 4, the device 1 forms an axial passage channel 6 extending in the longitudinal direction L, which passage channel extends from a first axial end 10 to a second axial end 11 and at least in the region of the ends 10, 11 has a continuous opening 12, 13 for lines or the like.

In alternative designs, the device can also be made in one piece.

The device 1 has a housing 8 having a housing wall 9, the housing wall forming the axial passage channel 6 and delimiting an interior space 14 of the device 1. According to the invention, the housing 8 has a substantially rectangular cross section, which in the assembled state of the device 1 is formed by four walls 16, 17, 18. A first wall 16 lies against a second wall 17. The further walls 18 formed in each case from a wall piece of the first part 3 and a wall piece of the second part 4 are in turn opposite one another and connect the walls 16 and 17.

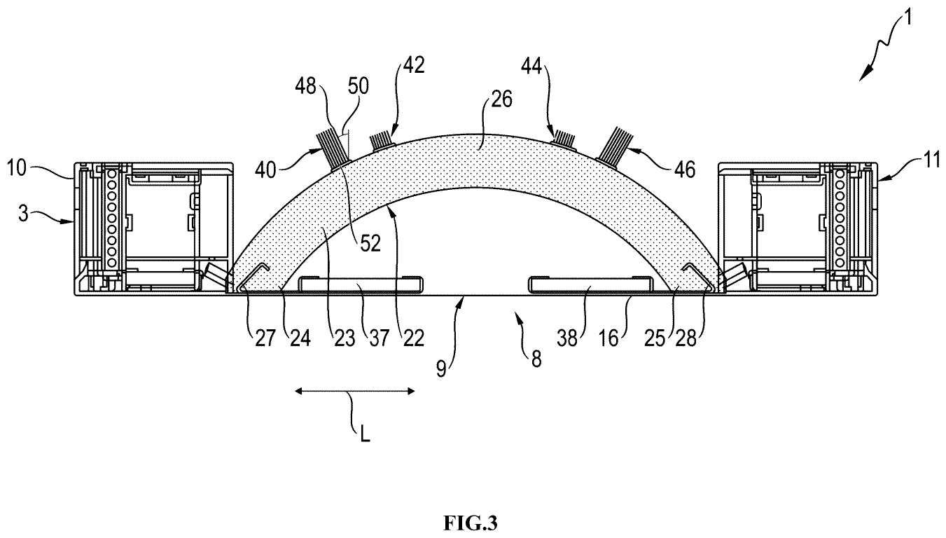

Since the first part 3 and the second part 4 are designed to be substantially comparable to one another, the following description of the first part 3 shown in FIG. 3 in isolation is representative of the second part 4.

The first part 3 comprises a first sealing means 22, which is designed here to have a planar foam element 23. The planar foam element 23 is curved transversely to the longitudinal direction L, such that a first end region 24 of the planar foam element 23 and a second end region 25 of the planar foam element 23 that is opposite the first end region 24 are each arranged in the region of the first wall 16. For this purpose, a holding means designed as a holding clip 27 and 28 is provided, by means of which the end regions 24 and 25 of the foam element 23 are secured to the first wall 16. In the assembled state of the device 1, a central region 26 of the foam element 23 arranged between the end regions 24 and 25 extends from the first wall 16 in the direction of the second wall 17 into the interior space 14.

In addition to the embodiment shown with a curved planar foam element, an already preformed foam element may also be used, which can have, for example, a similar curved shape to the foam element 23, or it may be designed to be trapezoidal.

According to the invention, in an extension region 30 of the foam element 23, two intumescent elements 37, 38 are connected to the first wall 16 between the end regions 24 and 25 in the longitudinal direction L, said intumescent elements being intended to ensure closing of the interior 14 in the event of a fire. Alternatively or additionally thereto, further intumescent elements may also be arranged, for example, in the axial end regions 10, 11 of the device 1.

According to the invention, the extension region 30 of the foam element 23 of the first part 3 in the longitudinal direction L corresponds to an extension region 30 of the foam element 23 of the second part 4, such that the common extension region 30 in the longitudinal direction L corresponds to the individual extension regions 30.

In alternative embodiments, the extension regions of the foam elements of the individual parts may differ from one another, a common extension region being defined by an intersection of the extension regions of the individual foam elements in the longitudinal direction L.

As can be seen in simplified form in FIG. 1 to FIG. 3, in each case two sealing arrangements 32, 33, 34, 35 are provided in the region of the axial ends 10, 11 of the device 1, each of which sealing arrangements forms a sealing plane that is perpendicular to the longitudinal direction L and which are each designed having a plurality of directly adjacent, elongate sealing elements 26.

The sealing elements 26 according to the invention have a substantially circular cross section, are designed to be flexible and resilient, and have an extension in their longitudinal direction that is many times greater than the cross section of the sealing elements 26. The sealing elements 26 are designed in this case as resilient lamellae having a plastics fiber made of polypropylene or polyethylene, but in alternative designs they may also be designed as brushes, bristles, strips, bands, tube elements, or the like and may comprise other materials such as metal, rubber, biological materials, or the like.

The sealing elements 26 may also be made with woven fabric, scrims, or paper materials, which are flexible, can be applied snugly to a shell surface of a line or the like routed through the device 1, and, if possible, exert a resilient force on the shell surface in order to ensure the tightest possible seal in the region around the shell surface of the line. The sealing elements 26 may furthermore have an intumescent material and for example be coated with an intumescent material or enclose an intumescent material, and in particular comprise a paper provided with intumescent material.

The sealing elements 26 of the first sealing arrangement 32 extend perpendicularly to the sealing elements 26 of the second sealing arrangement 33. The sealing elements 26 of the third sealing arrangement 34 and fourth sealing arrangement 35 are designed in a similar manner hereto, and are arranged in the region of the second axial end 11 of the device 1.

If a line, a pipe, a cable, or the like is routed through the device 1, the sealing elements 26 of the sealing arrangements 32, 33, 34, 35 are curved in such a way that they rest on a shell surface 5 of a line 2 routed through the device 1 and thereby provide a seal against the passage of fire gases and smoke and also achieve a particular degree of opaqueness.

In FIGS. 1 to 3, a third sealing means 40, a fifth sealing means 42, a seventh sealing means 44, and a ninth sealing means 46 can also be seen, which are each arranged on the first sealing means 22. Similarly, a fourth sealing means 41, a sixth sealing means 43, an eighth sealing means 45, and a tenth sealing means 47 are arranged on a second sealing means 31 arranged on the second part 4. According to the invention, all sealing means 40 to 47 are arranged completely within the common extension region 30.

The following description of the sealing means 40, 42, 44, 46 assigned to the part 3 is representative of the sealing means 41, 43, 45, 47 assigned to the part 4.

According to the invention, the sealing means 40, 42. 44, 46 each have a plurality of sealing elements 48, which may be designed to be comparable to the sealing elements 36. Preferably, the sealing elements 48 are designed as hairs of a brush, the hairs 48 of the brush in particular having a common longitudinal extension direction in the unloaded state of the device 1. According to the invention, the longitudinal extension direction of the hairs is not perpendicular to the longitudinal direction L of the device 1, but rather encloses an angle 50 together with a transverse plane Q that is transverse to the longitudinal direction L, which angle may be, for example, between 0° and 45°, for example approximately 30°.

The hairs 48 of the brushes are each arranged on a holding element 52, by means of which the brushes are arranged, in particular glued, directly on the first foam element 23. According to the invention, the third sealing means 40 and the fifth sealing means 42 are arranged on a side of the central region 26 of the foam element 23 facing the first opening 12 of the device 1 and the seventh sealing means 44 and the ninth sealing means 46 are arranged on a side of the central region 26 of the foam element 23 facing the second opening 13 of the device 1. A length of the sealing elements 48 of the fifth sealing means 42 and of the seventh sealing means 44, which are arranged closer to the central region 26 of the foam element 23 than the third sealing means 40 and the ninth sealing means 46, is shorter than the length of the sealing elements 48 of the third sealing means 40 and of the ninth sealing means 46.

In the assembled state of the unloaded device 1, the sealing elements 48 of the cooperating sealing means 40 to 47 of the first part 3 and of the second part 4 engage in a comb-like manner. In alternative embodiments, the end regions of the sealing elements of the cooperating sealing means may also stand flush with one another in the unloaded state of the device 1.

As can be seen in more detail in FIG. 1, sealing elements 48 of the sealing means 40 to 47 that cooperate with one another in the unloaded state of the device 1 engage in one another in a comb-like manner. In addition, the central regions 26 of the foam elements 23 adjoin one another over a particular extension region in the longitudinal direction L of the device 1, such that good gas tightness is achieved in the unloaded state of the device 1.

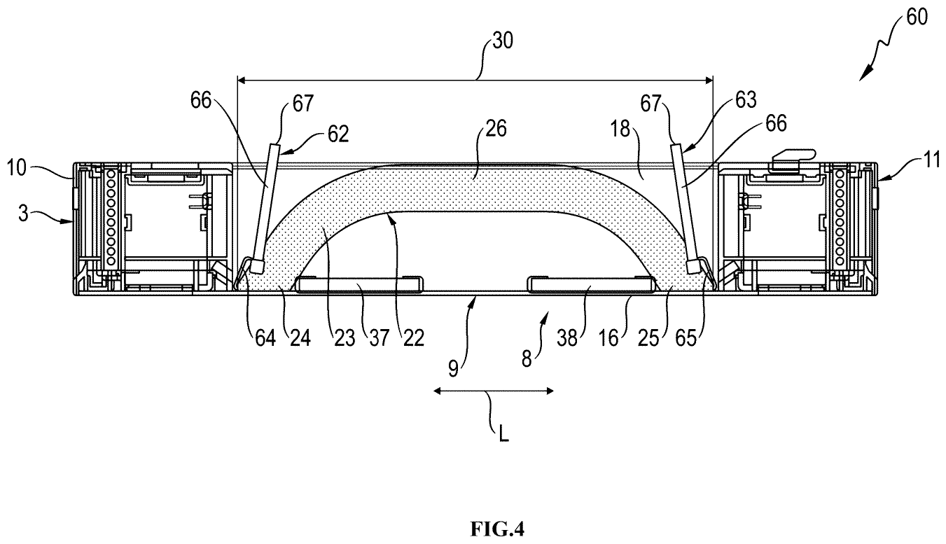

In the loaded state according to FIG. 3, in addition to the sealing arrangements 32 to 35, sealing is also provided in the region of the foam elements 23 and in the region of the sealing means 40 to 47 with respect to the line 2 routed through the device 1 and passage of gas is reliably prevented or passage of gas is greatly reduced. In FIGS. 4 to 6, an alternatively designed device 60, 70, and 80 is shown, only the differences from the device 1 being discussed below and reference otherwise being made to the statements regarding the device 1. In the devices 60, 70, and 80, only the first part 3 can be seen in FIGS. 4 to 6.

In the device 60 according to FIG. 4, a third sealing means 62 and a fifth sealing means 63 are provided, each of which is arranged in an end region 24 and 25, respectively, of the first sealing means 22. In contrast to the device 1, the third sealing means 62 and the fifth sealing means 63 are not directly connected to the foam element 23, but rather are arranged on a holding device 64 and 65, respectively. In this way, particularly robust securing of the sealing means 62 and 63 is achieved.

Furthermore, the holding means 64, 65 are comparable to the retaining clips 27, 28 of the device 1 for securing the end regions 24, 25 of the foam element 23 to the first wall 16 of the first part 3. Above that, the holding means 64, 65 each have a region for arrangement of the sealing elements 66.

The sealing elements 66 may be designed similarly to the sealing elements 48 and may have a greater length than the sealing elements 48 due to their arrangement in the vicinity of the end region 24 or 25 of the foam element 23. The sealing elements 48 extend at least up to the height of the first part 3, in particular into the second part 4, such that reliable cooperation and good sealing in conjunction with the corresponding sealing elements of the second part 4 is achieved. In contrast to the sealing elements 48, the end regions of the sealing elements 66 facing away from the holding means 64, 65 are further away from the relevant associated opening 12 or 13 than the regions of the sealing elements 66 arranged on the relevant holding device 64, 65. As viewed from the closest opening 12 or 13, the sealing elements 66 are thus inclined in the longitudinal direction L proceeding from their housing-side securing location in the direction of the other opening 13 or 12.

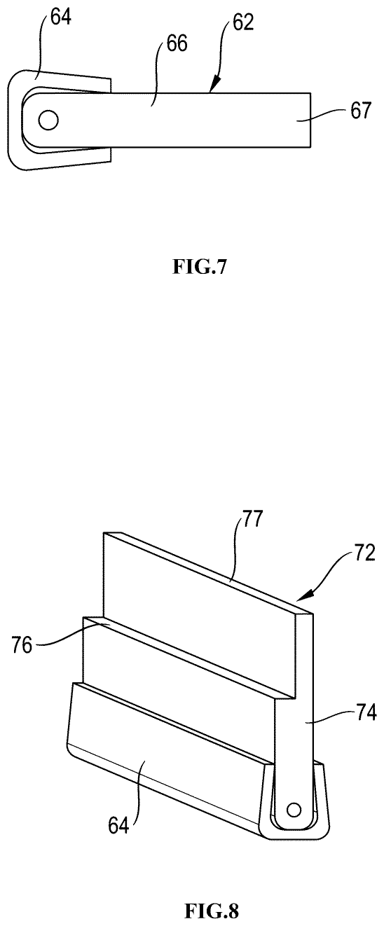

All sealing means 40 to 47, 62, and 63 may be designed, for example, in the manner shown in FIGS. 7 and 8.

The third sealing means 62 can be seen in more detail in FIG. 7. In this case, the sealing elements 66 are designed, for example, having horse hairs which are bent or deflected in the region of the holding means 64 such that all end regions 67 of the sealing elements 66 lie substantially in one plane and form a virtually flat surface.

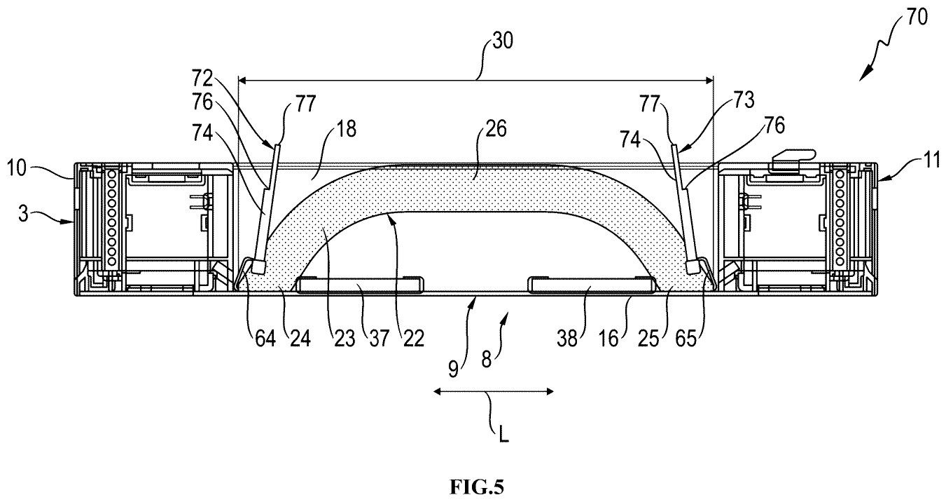

In the device 70 shown in FIG. 5, the sealing means 72 and 73 are designed according to the detailed representation in FIG. 8. End regions 76, 77 of the sealing elements 74 of the sealing means 72, 73 are at an offset to one another and thus extend unequally far from the holding means 64 and 65, respectively. In this way, particularly good sealing of the passage channel 6 can be achieved with little loading of the device 70.

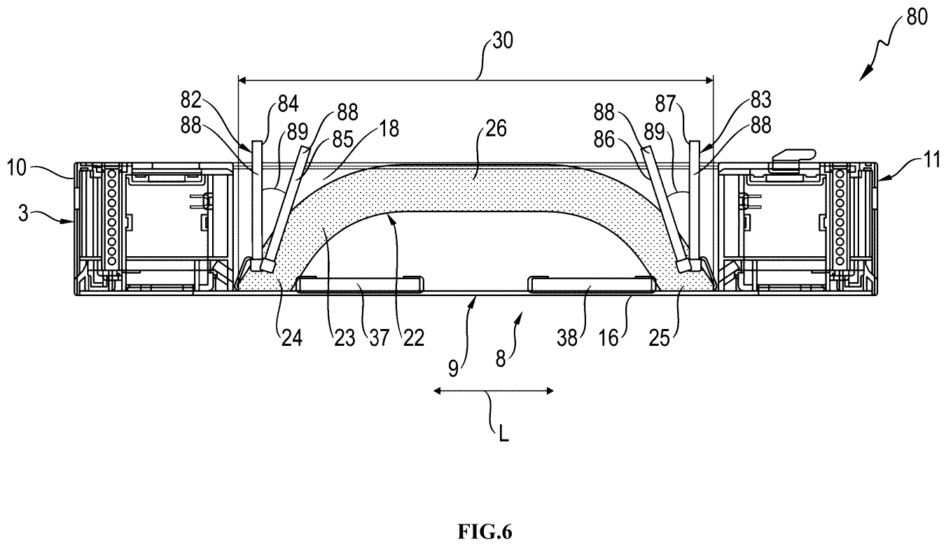

In the device 80 shown in FIG. 6, a third sealing means 82 designed as an alternative to the third sealing means 62 according to FIG. 4 and a fifth sealing means 83 designed as an alternative to the fifth sealing means 63 is provided.

The third sealing means 82 and the fifth sealing means 83 differ from the third sealing means 62 and the fifth sealing means 63 in that they each have two brushes 84, 85 and 86, 87, respectively, each of which is connected to the holding means 64 and the holding means 65, respectively. The brushes 84 to 87 each have sealing elements 88 which are designed similarly to the sealing elements 66, a sealing plane or sealing surface of the sealing elements 88 of the brush 84 and 87 being at an angle 89 with respect to a sealing plane or sealing surface of the sealing elements 88 of the brush 85 and 86, respectively. This improves sealing in the region of lines and the like routed through the device 80.

All sealing means 62, 63, 72, 73, 82, 83 of the devices 60, 70, 80 shown in FIGS. 4 to 6 are arranged completely in the common extension region 30 in the longitudinal direction L. The only feature pertinent for the assessment as to whether the relevant sealing means 62, 63, 72, 73, 82, 83 is arranged in the common extension region 30 is the relevant sealing means 62, 63, 72, 73, 82, 83 without the relevant holding means 64, 65, 74, 75 provided for arrangement.

By means of the devices 1, 60, 70, 80 described in more detail above, a significant air flow and thus a transfer of smoke and gas from one side of the device 1, 60, 70, 80 to the other side of the device 1, 60, 70, 80 through the passage channel 6 both in the unloaded state of the device 1. 60, 70, 80 and in the loaded state of the device 1, 60, 70, 80 is significantly reduced and, moreover, good opaqueness is achieved.

1. A device for routing lines, pipes, and/or cables through a building part, comprising:
a housing with a housing wall, the housing having an axial passage channel which is delimited by the housing wall, wherein the axial passage channel extends in a longitudinal direction (L), and has an opening at opposite ends, the housing having a first wall and a second wall opposite the first wall,
a first seal having a curved shape being arranged in a housing interior, end regions of which first seal in each case being operatively connected to the first wall and a central region of which first seal extending in a direction of the second wall, and
a second seal having a curved shape being arranged in the housing interior, end regions of which second seal being operatively connected to the second wall and the central region of which second seal extending in a direction of the first wall,
wherein the first seal and the second seal having a common extension region in the longitudinal direction (L) of the device,
wherein the first seal and the second seal cooperate with one another by the central regions, a third seal being assigned to the first seal in the common extension region and a fourth seal being assigned to the second seal in the common extension region, and the third seal and the fourth seal cooperating with one another.

2. The device according to claim 1, wherein the third seal and/or the fourth seal is connected to the first seal and/or to the second seal, respectively.

3. The device according to claim 2, wherein the third seal and/or the fourth seal is connected to the first seal and/or to the second seal, respectively, by an adhesive connection or by of a welded connection.

4. The device according to claim 1, wherein the third seal and/or the fourth seal is connected to the first wall and/or to the second wall, respectively, by a holder.

5. The device according to claim 4, wherein the holder is configured to secure an end region of the first seal and second seal to the first wall and second wall, respectively.

6. The device according to claim 1, wherein a fifth seal is assigned to the first seal in the common extension region and a sixth seal is assigned to the second seal in the common extension region, and the fifth seal and the sixth seal cooperating with one another.

7. The device according to claim 1, wherein the third seal and/or the fourth seal and/or the fifth seal and/or the sixth seal has at least two sealing elements.

8. The device according to claim 1, wherein the third seal and/or the fourth seal and/or the fifth seal and/or the sixth seal each have inverted sealing elements, the two end regions of the sealing elements being flush with one another.

9. The device according to claim 1, wherein the third seal and/or the fourth seal and/or the fifth seal and/or the sixth seal each have inverted sealing elements, the two end regions of the sealing elements being offset with respect to one another.

10. The device according to claim 1, wherein the first seal and the second seal are designed as a foam element.

11. The device according to claim 1, the third seal and/or the fourth seal and/or the fifth seal and/or the sixth seal have lamellae, brushes, bristles, strips, bands, or tubes.

12. The device according to claim 1, wherein the third seal and/or the fourth seal and/or the fifth seal and/or the sixth seal comprise plastics material and/or biological material.

13. The device according to claim 1, further comprising a sealing arrangement in a region of the openings of the device.

14. The device according to claim 1, further comprising at least one intumescent element.

15. The device according to claim 12, wherein the third seal and/or the fourth seal and/or the fifth seal and/or the sixth seal comprise polyamide, nylon, polyester, or rubber as the plastics material, and/or horse hair as the biological material.
